(19) United States
(12) Patent Application Publication
(10) Pub. No.: US 2013/0135324 A1
(43) Pub. Date: May 30, 2013

(54) SYSTEMS, DEVICES, AND METHODS FOR DRIVING AN ANALOG INTERFEROMETRIC MODULATOR

(71) Applicants: John H. Hong, San Clemente, CA (US); Chong U. Lee, San Diego, CA (US); Gene W. Marsh, Encinitas, CA (US)

(72) Inventors: John H. Hong, San Clemente, CA (US); Chong U. Lee, San Diego, CA (US); Gene W. Marsh, Encinitas, CA (US)

(73) Assignee: QUALCOMM MEMS Technologies, Inc., San Diego, CA (US)

(21) Appl. No.: 13/306,802

(22) Filed: Nov. 29, 2011

(51) Int. Cl. G06F 15/16; G02B 26/00

(52) U.S. Cl. 345/504; 359/290

(57) ABSTRACT

This disclosure provides systems, methods, and apparatus for calibrating and controlling the actuation of an analog interferometric modulator. In one aspect, an electrode of a movable layer of the analog interferometric modulator may include a part for receiving a drive voltage, and an electrically isolated part. A voltage may be sensed from the electrically isolated part, and used to determine the position of the movable layer and/or provide feedback to the drive voltage.

### TECHNICAL FIELD

This disclosure relates to driving schemes and calibration methods for analog interferometric modulators, and for detecting the position of a movable conductor disposed between two other conductors.

### DESCRIPTION OF THE RELATED TECHNOLOGY

Electromechanical systems (EMS) include devices having electrical and mechanical elements, actuators, transducers, sensors, optical components (e.g., mirrors) and electronics. Electromechanical systems can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of EMS device is called an interferometric modulator (IMOD). As used herein, the term interferometric modulator or interferometric light modulator refers to a device that selectively absorbs and/or reflects light using the principles of optical interference. In some implementations, an interferometric modulator may include a pair of conductive plates, one or both of which may be transparent and/or reflective, wholly or in part, and capable of relative motion upon application of an appropriate electrical signal. In an implementation, one plate may include a stationary layer deposited on a substrate and the other plate may include a reflective membrane separated from the stationary layer by an air gap. The position of one plate in relation to another can change the optical interference of light incident on the interferometric modulator. Interferometric modulator devices have a wide range of applications, and are anticipated to be used in improving existing products and creating new products, especially those with display capabilities.

### SUMMARY

The system, method, and devices of the invention each have several innovative aspects, no single one of which is solely responsible for its desirable attributes disclosed herein.

One innovative aspect of the subject matter described in this disclosure can be implemented in a device for modulating light. In this aspect, a device for modulating light may include at least first, second, third, and fourth electrodes. A fixed voltage may be applied across the first and second electrodes, a variable voltage may be applied to the third electrode; and a voltage sensor may be coupled to the fourth electrode.

Other innovative aspects involve methods of driving devices for modulating light. In one such aspect, a method of driving a device for modulating light includes applying a first voltage across a first electrode and a second electrode, applying a second voltage to a third electrode, and sensing a voltage of a fourth electrode.

In another innovative aspect, a device for modulating light includes means for applying a first voltage across a first electrode and a second electrode, means for applying a second voltage to a third electrode, and means for sensing a voltage of a fourth electrode.

Details of one or more implementations of the subject matter described in this specification are set forth in the accompanying drawings and the description below. Although the examples provided in this disclosure are primarily described in terms of electromechanical systems (EMS) and microelectromechanical systems (MEMS)-based displays, the concepts provided herein may apply to other types of displays, such as liquid crystal displays, organic light-emitting diode (“OLED”) displays and field emission displays. Other features, aspects, and advantages will become apparent from the description, the drawings, and the claims. Note that the relative dimensions of the following figures may not be drawn to scale.

### BRIEF DESCRIPTION OF THE DRAWINGS

FIGS. 1A and 1B show examples of isometric views depicting a pixel of an interferometric modulator (IMOD) display device in two different states.

FIG. 2 shows an example of a schematic circuit diagram illustrating a driving circuit array for an optical MEMS display device.

FIG. 3 shows an example of a schematic partial cross-section illustrating one implementation of the structure of the driving circuit and the associated display element of FIG. 2.

FIG. 4 shows an example of a schematic exploded partial perspective view of an optical MEMS display device having an interferometric modulator array and a backplate with embedded circuitry.

FIG. 5 shows a cross-section of an interferometric modulator having two fixed layers and a movable third layer.

FIG. 6 shows an example of a schematic circuit diagram illustrating a driving circuit array for an optical EMS display device having the structure of FIG. 5.

FIGS. 7A-7C show cross-sections of the two fixed layers and the movable layer of the interferometric modulator of FIG. 5 illustrating stacks of materials.

FIG. 8 shows a schematic representation of the interferometric modulator and voltage sources illustrated in FIG. 5.

FIG. 9A shows a diagram illustrating a top view of an electrode having two electrically isolated portions.

FIG. 9B shows a diagram illustrating a top view of another electrode having two electrically isolated portions.

FIG. 10 shows a schematic representation of the electrode of FIG. 9A or 9B implemented in the interferometric modulator of FIG. 5.

FIG. 11 shows a flow diagram of a process for determining a position of a movable conductive layer disposed between two fixed conductive layers.

FIG. 12 shows an illustration of a voltage sensor configured to provide feedback to the electrode of FIG. 9A.

FIG. 13 shows a flowchart of a process for driving a device for modulating light.

FIG. 14 shows a circuit diagram illustrating an implementation of the sensor and feedback of FIG. 12.

FIG. 15 shows a diagram illustrating an array of interferometric modulators incorporating voltage sensing and feedback to position a middle layer of each modulator.

FIG. 16 shows a cross-section of an interferometric modulator having fixed layers and a movable layer with a fixed sense electrode.

FIG. 17 shows a diagram illustrating another implementation of an array of interferometric modulators constructed as shown in FIG. 16 incorporating voltage sensing and feedback to position a movable layer of each modulator.

FIGS. 18A and 18B show examples of system block diagrams illustrating a display device that includes a plurality of interferometric modulators.

FIG. 19 is an example of a schematic exploded perspective view of an electronic device having an optical MEMS display.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device or system that can be configured to display an image, whether in motion (e.g., video) or stationary (e.g., still image), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, GPS receivers/navigators, cameras, MP3 players, camcorders, game consoles, wrist watches, clocks, calculators, television monitors, flat panel displays, electronic reading devices (i.e., e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS), microelectromechanical systems (MEMS) and non-MEMS applications), aesthetic structures (e.g., display of images on a piece of jewelry) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

Certain methods and devices described herein relate to implementations of analog interferometric modulators. An analog interferometric modulator may be driven to a range of different positions with different optical properties. Methods and systems for calibrating and controlling the position of an analog interferometric modulator to achieve various optical states are disclosed. In some implementations, a movable layer includes an electrically isolated sensing electrode. In other implementations, a fixed substrate includes an electrically isolated sensing electrode. The voltage on the sense electrode may be used in a feedback loop to control the position of the movable layer in response to a drive voltage.

Particular implementations of the subject matter described in this disclosure can be implemented to realize one or more of the following potential advantages. The systems and methods disclosed herein can allow fast and accurate modulator positioning and increase the ability to produce a high performance array of modulators in a display device even when the physical properties of the modulators of the array include performance differences related to fabrication tolerances.

An example of a suitable EMS or MEMS device, to which the described implementations may apply, is a reflective display device. Reflective display devices can incorporate interferometric modulators (IMODs) to selectively absorb and/or reflect light incident thereon using principles of optical interference. IMODs can include an absorber, a reflector that is movable with respect to the absorber, and an optical resonant cavity defined between the absorber and the reflector. The reflector can be moved to two or more different positions, which can change the size of the optical resonant cavity and thereby affect the reflectance of the interferometric modulator. The reflectance spectrums of IMODs can create fairly broad spectral bands which can be shifted across the visible wavelengths to generate different colors. The position of the spectral band can be adjusted by changing the thickness of the optical resonant cavity. One way of changing the optical resonant cavity is by changing the position of the reflector.

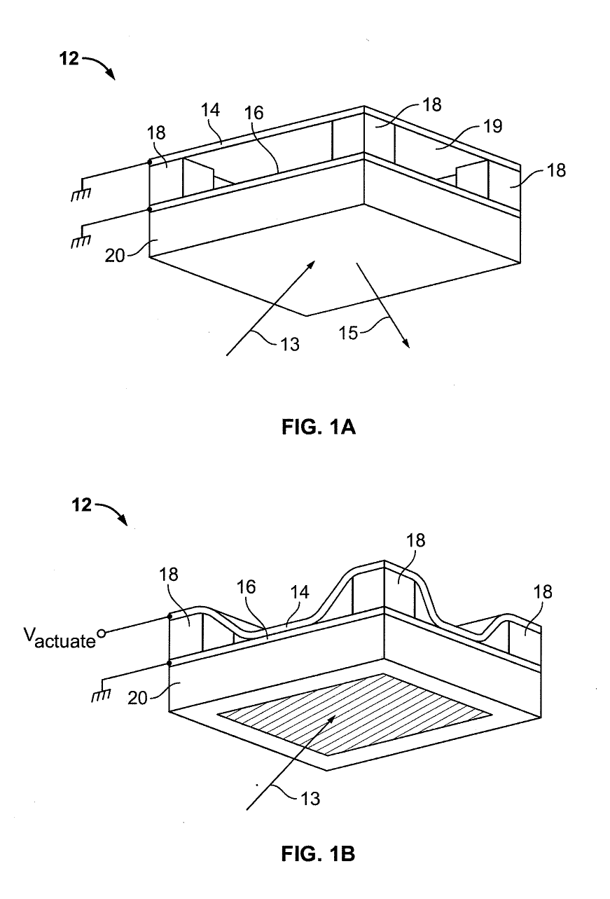

FIGS. 1A and 1B show examples of isometric views depicting a pixel of an interferometric modulator (IMOD) display device in two different states. The IMOD display device includes one or more interferometric MEMS display elements. In these devices, the pixels of the MEMS display elements can be in either a bright or dark state. In the bright (“relaxed,” “open” or “on”) state, the display element reflects a large portion of incident visible light, e.g., to a user. Conversely, in the dark (“actuated,” “closed” or “off”) state, the display element reflects little incident visible light. In some implementations, the light reflectance properties of the on and off states may be reversed. MEMS pixels can be configured to reflect predominantly at particular wavelengths allowing for a color display in addition to black and white.

The IMOD display device can include a row/column array of IMODs. Each IMOD can include a pair of reflective layers, i.e., a movable reflective layer and a fixed partially reflective layer, positioned at a variable and controllable distance from each other to form an air gap (also referred to as an optical gap or cavity). The movable reflective layer may be moved between at least two positions. In a first position, i.e., a relaxed position, the movable reflective layer can be positioned at a relatively large distance from the fixed partially reflective layer. In a second position, i.e., an actuated position, the movable reflective layer can be positioned more closely to the partially reflective layer. Incident light that reflects from the two layers can interfere constructively or destructively depending on the position of the movable reflective layer, producing either an overall reflective or non-reflective state for each pixel. In some implementations, the IMOD may be in a reflective state when unactuated, reflecting light within the visible spectrum, and may be in a dark state when unactuated, absorbing and/or destructively interfering light wihtin the visible range. In some other implementations, however, an IMOD may be in a dark state when unactuated, and in a reflective state when actuated. In some implementations, the introduction of an applied voltage can drive the pixels to change states. In some other implementations, an applied charge can drive the pixels to change states.

The depicted pixels in FIGS. 1A and 1B depict two different states of an IMOD 12. In the IMOD 12 of FIG. 1A, a movable reflective layer 14 is illustrated in a relaxed position at a predetermined distance from an optical stack 16, which includes a partially reflective layer. Since no voltage is applied across the IMOD 12 in FIG. 1A, the movable reflective layer 14 remained in a relaxed or unactuated state. In the IMOD 12 of FIG. 1B, the movable reflective layer 14 is illustrated in an actuated position adjacent to the optical stack 16. The voltage V_{actuate} applied across the IMOD 12 in FIG. 1B is sufficient to actuate the movable reflective layer 14 to an actuated position.

In FIG. 1, the reflective properties of pixels 12 are generally illustrated with arrows 13 indicating light incident upon the pixels 12, and light 15 reflecting from the pixel 12 on the left. A person having ordinary skill in the art will readily recognize that most of the light 13 incident upon the pixels 12 will be transmitted through the transparent substrate 20, toward the optical stack 16. A portion of the light incident upon the optical stack 16 will be transmitted through the partially reflective layer of the optical stack 16, and a portion will be reflected back through the transparent substrate 20. The portion of light 13 that is transmitted through the optical stack 16 will be reflected at the movable reflective layer 14, back toward (and through) the transparent substrate 20. Interference (constructive or destructive) between the light reflected from the partially reflective layer of the optical stack 16 and the light reflected from the movable reflective layer 14 will determine the wavelength(s) of light 15 reflected from the pixels 12.

The optical stack 16 can include a single layer or several layers. The layer(s) can include one or more of an electrode layer, a partially reflective and partially transmissive layer and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals, such as chromium (Cr), semiconductors, and dielectrics. The partially reflective layer can be formed of one or more layers of materials, and each of the layers can be formed of a single material or a combination of materials. In some implementations, the optical stack 16 can include a single semi-transparent thickness of metal or semiconductor which serves as both an optical absorber and conductor, while different, electrically more conductive layers or portions (e.g., of the optical stack 16 or of other structures of the IMOD) can serve to bus signals between IMOD pixels. The optical stack 16 also can include one or more insulating or dielectric layers covering one or more conductive layers or an electrically conductive/optically absorptive layer.

In some implementations, the lower electrode 16 is grounded at each pixel. In some implementations, this may be accomplished by depositing a continuous optical stack 16 onto the substrate and grounding the entire sheet at the periphery of the deposited layers. In some implementations, a highly conductive and reflective material, such as aluminum (Al), may be used for the movable reflective layer 14. The movable reflective layer 14 may be formed as a metal layer or layers deposited on top of posts 18 and an intervening sacrificial material deposited between the posts 18. When the sacrificial material is etched away, a defined gap 19, or optical cavity, can be formed between the movable reflective layer 14 and the optical stack 16. In some implementations, the spacing between posts 18 may be approximately 1-1000 um, while the gap 19 may be approximately less than 10,000 Angstroms (Å).

In some implementations, each pixel of the IMOD, whether in the actuated or relaxed state, is essentially a capacitor formed by the fixed and moving reflective layers. When no voltage is applied, the movable reflective layer 14a remains in a mechanically relaxed state, as illustrated by the pixel 12 in FIG. 1A, with the gap 19 between the movable reflective layer 14 and optical stack 16. However, when a potential difference, e.g., voltage, is applied to at least one of the movable reflective layer 14 and optical stack 16, the capacitor formed at the corresponding pixel becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated pixel 12 in FIG. 1B. The behavior is the same regardless of the polarity of the applied potential difference. Though a series of pixels in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

In some implementations, the optical stacks 16 in a series or array of IMODs can serve as a common electrode that provides a common voltage to one side of the IMODs of the display device. The movable reflective layers 14 may be formed as an array of separate plates arranged in, for example, a matrix form, as described further below. The separate plates can be supplied with voltage signals for driving the IMODs.

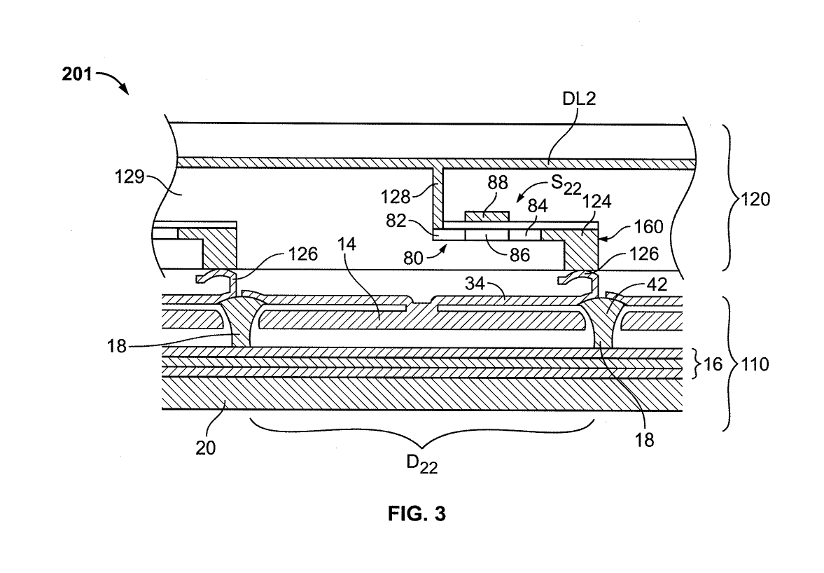

The details of the structure of interferometric modulators that operate in accordance with the principles set forth above may vary widely. For example, the movable reflective layers 14 of each IMOD may be attached to supports at the corners only, e.g., on tethers. As shown in FIG. 3, a flat, relatively rigid reflective layer 14 may be suspended from a deformable layer 34, which may be formed from a flexible metal. This architecture allows the structural design and materials used for the electromechanical aspects and the optical aspects of the modulator to be selected, and to function, independently of each other. Thus, the structural design and materials used for the reflective layer 14 can be optimized with respect to the optical properties, and the structural design and materials used for the deformable layer 34 can be optimized with respect to desired mechanical properties. For example, the reflective layer 14 portion may be aluminum, and the deformable layer 34 portion may be nickel. The deformable layer 34 may connect, directly or indirectly, to the substrate 20 around the perimeter of the deformable layer 34. These connections may form the support posts 18.

In implementations such as those shown in FIGS. 1A and 1B, the IMODs function as direct-view devices, in which images are viewed from the front side of the transparent substrate 20, i.e., the side opposite to that upon which the modulator is arranged. In these implementations, the back portions of the device (that is, any portion of the display device behind the movable reflective layer 14, including, for example, the deformable layer 34 illustrated in FIG. 3) can be configured and operated upon without impacting or negatively affecting the image quality of the display device, because the reflective layer 14 optically shields those portions of the device. For example, in some implementations a bus structure (not illustrated) can be included behind the movable reflective layer 14 which provides the ability to separate the optical properties of the modulator from the electromechanical properties of the modulator, such as voltage addressing and the movements that result from such addressing.

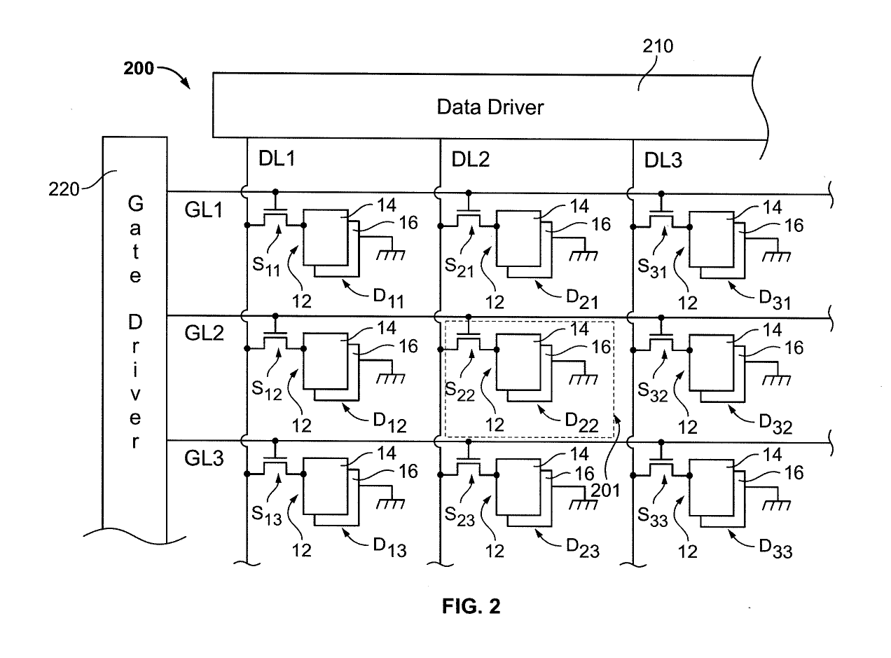

FIG. 2 shows an example of a schematic circuit diagram illustrating a driving circuit array 200 for an optical MEMS display device. The driving circuit array 200 can be used for implementing an active matrix addressing scheme for providing image data to display elements D₁₁-Dₘₙ of a display array assembly.

The driving circuit array 200 includes a data driver 210, a gate driver 220, first to m-th data lines DL1-DLm, first to n-th gate lines GL1-GLn, and an array of switches or switching circuits S₁₁-Sₘₙ. Each of the data lines DL1-DLm extends from the data driver 210, and is electrically connected to a respective column of switches S₁₁-S₁ₙ, S₂₁-S₂ₙ, . . . , Sₘ₁-Sₘₙ. Each of the gate lines GL1-GLn extends from the gate driver 220, and is electrically connected to a respective row of switches S₁₁-Sₘ₁, S₁₂-Sₘ₂, . . . , S₁ₙ-Sₘₙ. The switches S₁₁-Sₘₙ are electrically coupled between one of the data lines DL1-DLm and a respective one of the display elements D₁₁-Dₘₙ and receive a switching control signal from the gate driver 220 via one of the gate lines GL1-GLn. The switches S₁₁-Sₘₙ are illustrated as single FET transistors, but may take a variety of forms such as two transistor transmission gates (for current flow in both directions) or even mechanical MEMS switches.

The data driver 210 can receive image data from outside the display, and can provide the image data on a row by row basis in a form of voltage signals to the switches S₁₁-Sₘₙ via the data lines DL1-DLm. The gate driver 220 can select a particular row of display elements D₁₁-Dₘ₁, D₁₂-Dₘ₂, . . . , D₁ₙ-Dₘₙ by turning on the switches S₁₁-Sₘ₁, S₁₂-Sₘ₂, . . . , S₁ₙ-Sₘₙ associated with the selected row of display elements D₁₁-Dₘ₁, D₁₂-Dₘ₂, . . . , D₁ₙ-Dₘₙ. When the switches S₁₁-Sₘ₁, S₁₂-Sₘ₂, . . . , S₁ₙ-Sₘₙ in the selected row are turned on, the image data from the data driver 210 is passed to the selected row of display elements D₁₁-Dₘ₁, D₁₂-Dₘ₂, . . . , D₁ₙ-Dₘₙ.

During operation, the gate driver 220 can provide a voltage signal via one of the gate lines GL1-GLn to the gates of the switches S₁₁-Sₘₙ in a selected row, thereby turning on the switches S₁₁-Sₘₙ. After the data driver 210 provides image data to all of the data lines DL1-DLm, the switches S₁₁-Sₘₙ of the selected row can be turned on to provide the image data to the selected row of display elements D₁₁-Dₘ₁, D₁₂-Dₘ₂, . . . , D₁ₙ-Dₘₙ, thereby displaying a portion of an image. For example, data lines DL that are associated with pixels that are to be actuated in the row can be set to, e.g., 10-volts (could be positive or negative), and data lines DL that are associated with pixels that are to be released in the row can be set to, e.g., O-volts. Then, the gate line GL for the given row is asserted, turning the switches in that row on, and applying the selected data line voltage to each pixel of that row. This charges and actuates the pixels that have 10-volts applied, and discharges and releases the pixels that have O-volts applied. Then, the switches S₁₁-Sₘₙ can be turned off. The display elements D₁₁-Dₘ₁, D₁₂-Dₘ₂, . . . , D₁ₙ-Dₘₙ can hold the image data because the charge on the actuated pixels will be retained when the switches are off, except for some leakage through insulators and the off state switch. Generally, this leakage is low enough to retain the image data on the pixels until another set of data is written to the row. These steps can be repeated to each succeeding row until all of the rows have been selected and image data has been provided thereto. In the implementation of FIG. 2, the lower electrode 16 is grounded at each pixel. In some implementations, this may be accomplished by depositing a continuous optical stack 16 onto the substrate and grounding the entire sheet at the periphery of the deposited layers. FIG. 3 is an example of a schematic partial cross-section illustrating one implementation of the structure of the driving circuit and the associated display element of FIG. 2.

FIG. 3 shows an example of a schematic partial cross-section illustrating one implementation of the structure of the driving circuit and the associated display element of FIG. 2. The portion 201 of the driving circuit array 200 includes the switch S₂₂ at the second column and the second row, and the associated display element D₂₂. In the illustrated implementation, the switch S₂₂ includes a transistor 80. Other switches in the driving circuit array 200 can have the same configuration as the switch S₂₂.

FIG. 3 also includes a portion of a display array assembly 110, and a portion of a backplate 120. The portion of the display array assembly 110 includes the display element D₂₂ of FIG. 2. The display element D₂₂ includes a portion of a front substrate 20, a portion of an optical stack 16 formed on the front substrate 20, supports 18 formed on the optical stack 16, a movable electrode 14/34 supported by the supports 18, and an interconnect 126 electrically connecting the movable electrode 14/34 to one or more components of the backplate 120.

The portion of the backplate 120 includes the second data line DL2 and the switch S₂₂ of FIG. 2, which are embedded in the backplate 120. The portion of the backplate 120 also includes a first interconnect 128 and a second interconnect 124 at least partially embedded therein. The second data line DL2 extends substantially horizontally through the backplate 120. The switch S₂₂ includes a transistor 80 that has a source 82, a drain 84, a channel 86 between the source 82 and the drain 84, and a gate 88 overlying the channel 86. The transistor 80 can be a thin film transistor (TFT) or metal-oxide-semiconductor field effect transistor (MOSFET). The gate of the transistor 80 can be formed by gate line GL2 extending through the backplate 120 perpendicular to data line DL2. The first interconnect 128 electrically couples the second data line DL2 to the source 82 of the transistor 80.

The transistor 80 is coupled to the display element D₂₂ through one or more vias 160 through the backplate 120. The vias 160 are filled with conductive material to provide electrical connection between components (for example, the display element D₂₂) of the display array assembly 110 and components of the backplate 120. In the illustrated implementation, the second interconnect 124 is formed through the via 160, and electrically couples the drain 84 of the transistor 80 to the display array assembly 110. The backplate 120 also can include one or more insulating layers 129 that electrically insulate the foregoing components of the driving circuit array 200.

As shown in FIG. 3, the display element D₂₂ can be an interferometric modulator that has a first terminal coupled to the transistor 80, and a second terminal coupled to a common electrode that can be formed by at least part of an optical stack 16. The optical stack 16 of FIG. 3 is illustrated as three layers, a top dielectric layer described above, a middle partially reflective layer (such as chromium) also described above, and a lower layer including a transparent conductor (such as indium-tin-oxide (ITO)). The common electrode is formed by the ITO layer and can be coupled to ground at the periphery of the display.

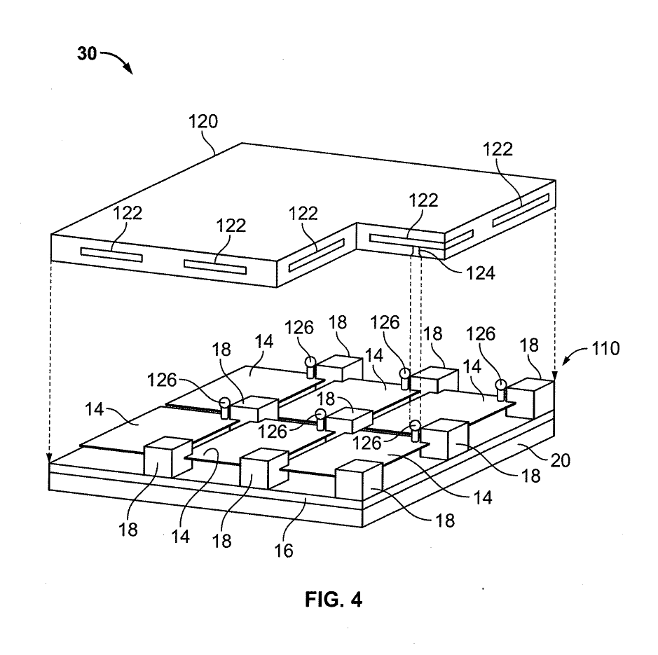

FIG. 4 shows an example of an exploded partial perspective view of an optical MEMS display device 30 having an interferometric modulator array and a backplate with embedded circuitry. The display device 30 includes a display array assembly 110 and a backplate 120. In some implementations, the display array assembly 110 and the backplate 120 can be separately pre-formed before being attached together. In some other implementations, the display device 30 can be fabricated in any suitable manner, such as, by forming components of the backplate 120 over the display array assembly 110 by deposition.

The display array assembly 110 can include a front substrate 20, an optical stack 16, supports 18, movable electrodes 14, and interconnects 126. The backplate 120 includes backplate components 122 at least partially embedded therein, and one or more backplate interconnects 124.

The optical stack 16 of the display array assembly 110 can be a substantially continuous layer covering at least the array region of the front substrate 20. The optical stack 16 can include a substantially transparent conductive layer that is electrically connected to ground. The movable electrodes 14/34 can be separate plates having, e.g., a square or rectangular shape. The movable electrodes 14/34 can be arranged in a matrix form such that each of the movable electrodes 14/34 can form part of a display element. In the implementation of FIG. 4, the movable electrodes 14/34 are supported by the supports 18 at four corners.

Each of the interconnects 126 of the display array assembly 110 serves to electrically couple a respective one of the movable electrodes 14/34 to one or more backplate components 122. In the illustrated implementation, the interconnects 126 of the display array assembly 110 extend from the movable electrodes 14/34, and are positioned to contact the backplate interconnects 124. In another implementation, the interconnects 126 of the display array assembly 110 can be at least partially embedded in the supports 18 while being exposed through top surfaces of the supports 18. In such an implementation, the backplate interconnects 124 can be positioned to contact exposed portions of the interconnects 126 of the display array assembly 110. In yet another implementation, the backplate interconnects 124 can extend to and electrically connect to the movable electrodes 14 without actual attachment to the movable electrodes 14, such as the interconnects 126 of FIG. 4.

In addition to the bistable interferometric modulators described above, which have a relaxed state and an actuated state, interferometric modulators may be designed to have a plurality of states. For example, an analog interferometric modulator (AIMOD) may have a range of color states. In one AIMOD implementation, a single interferometric modulator can be actuated into, e.g., a red state, a green state, a blue state, a black state, or a white state. Accordingly, a single interferometric modulator may be configured to have various states with different light reflectance properties over a wide range of the optical spectrum. The optical stack of an AIMOD may differ from the bi-stable display elements described above. These differences may produce different optical results. For example, in the bi-stable elements described above, the closed state gives the bi-stable element a black reflective state. An analog interferometric modulator, however, may have a white reflective state when the electrodes are in a similar position to the closed state of the bi-stable element.

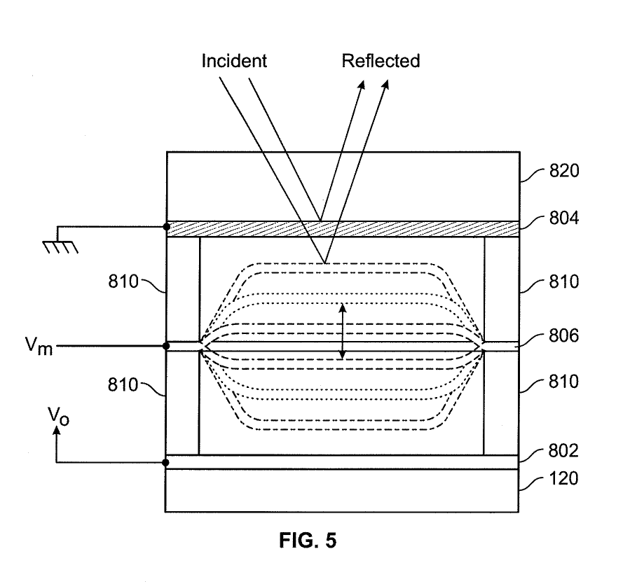

FIG. 5 shows a cross-section of an interferometric modulator having two fixed layers and a movable third layer. Specifically, FIG. 5 shows an implementation of an analog interferometric modulator having a fixed first layer 802, a fixed second layer 804, and a movable third layer 806 positioned between the fixed first and second layers 802 and 804. Each of the layers 802, 804, and 806 may include an electrode or other conductive material. For example, the first layer 802 may include a plate made of metal. Each of the layers 802, 804, and 806 may be stiffened using a stiffening layer formed on or deposited on the respective layer. In one implementation, the stiffening layer includes a dielectric. The stiffening layer may be used to keep the layer to which it is attached rigid and substantially flat. Some implementations of the modulator 800 may be referred to as a three-terminal interferometric modulator.

The three layers 802, 804, and 806 are electrically insulated by insulating posts 810. The movable third layer 806 is suspended from the insulating posts 810. The movable third layer 806 is configured to deform such that the movable third layer 806 may be displaced in a generally upward direction toward the first layer 802, or may be displaced in a generally downward direction toward to the second layer 804. In some implementations, the first layer 802 also may be referred to as the top layer or top electrode. In some implementations, the second layer 804 also may be referred to as the bottom layer or bottom electrode. The interferometric modulator 800 may be supported by a substrate 820.

In FIG. 5, the movable third layer 806 is illustrated as being in an equilibrium position with the solid lines. As illustrated in FIG. 5, a fixed voltage difference may be applied between the first layer 802 and the second layer 804. In this implementation, a voltage V₀ is applied to layer 802 and layer 804 is grounded. If a variable voltage Vₘ is applied to the movable third layer 806, then as that voltage Vₘ approaches V₀, the movable third layer 806 will be electrostatically pulled toward grounded layer 804. As that voltage Vₘ approaches ground, the movable third layer 806 will be electrostatically pulled toward layer 802. If a voltage at the midpoint of these two voltages (V₀/2 in this implementation) is applied to movable third layer 806, then the movable third layer 806 will be maintained in its equilibrium position indicated with solid lines in FIG. 5. By applying a variable voltage to the movable third layer 806 that is between the voltages on the outer layers 802 and 804, the movable third layer 806 can be positioned at a desired location between the outer layers 802 and 804, producing a desired optical response. The voltage difference V₀ between the outer layers can vary widely depending on the materials and construction of the device, and in many implementations may be in the range of about 5-20 volts. It also may be noted that as the movable third layer 806 moves away from this equilibrium position, it will deform or bend. In such deformed or bent configuration, an elastic spring force mechanically biases the movable third layer 806 toward the equilibrium position. This mechanical force also contributes to the final position of the movable third layer 806 when a voltage V is applied there.

The movable third layer 806 may include a mirror to reflect light entering the interferometric modulator 800 through substrate 820. The mirror may include a metal material. The second layer 804 may include a partially absorbing material such that the second layer 804 acts as an absorbing layer. When light reflected from the mirror is viewed from the side of the substrate 820, the viewer may perceive the reflected light as a certain color. By adjusting the position of the movable third layer 806, certain wavelengths of light may be selectively reflected.

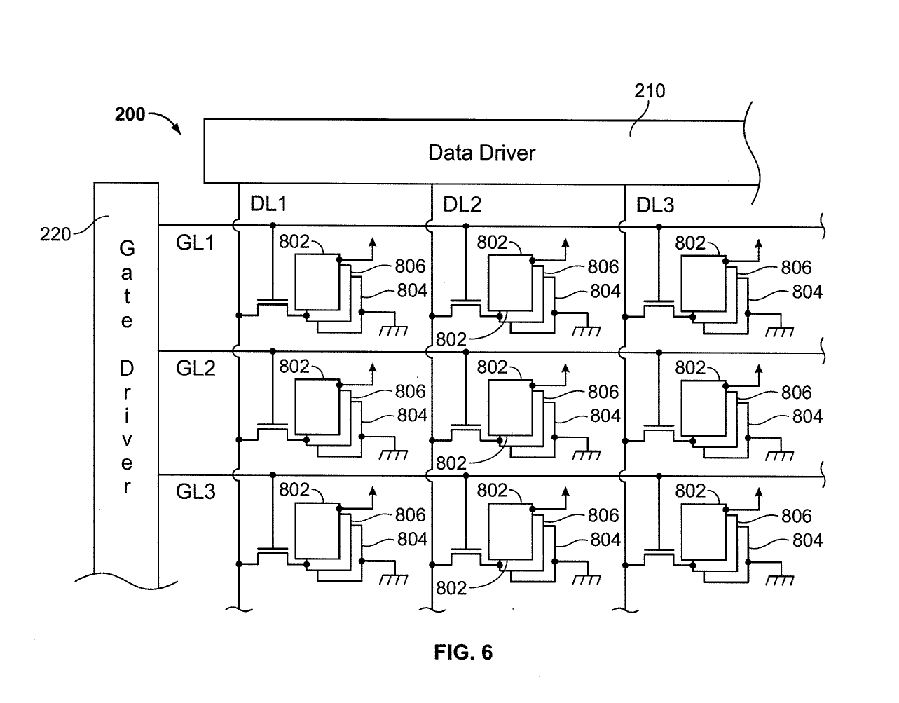

FIG. 6 shows an example of a schematic circuit diagram illustrating a driving circuit array for an optical EMS display device having the structure of FIG. 5. The overall apparatus shares many similarities to the structure of FIG. 2 that uses the bistable interferometric modulators. As shown in FIG. 6, however, an additional upper layer 802 is provided for each display element. This upper layer 802 may be deposited on the underside of the backplate 120 shown in FIGS. 3 and 4, and may have a voltage V₀ applied thereto. These implementations are driven in a manner similar to that described above with reference to FIG. 2, except the voltages provided on the data lines DL1-DLn can be placed at a range of voltages between V₀ and ground, rather than at one of only two different voltages. In this way, the movable third layers 806 of the display elements along a row each can be independently placed in any particular desired position between the upper and lower layers when the row is written by asserting the gate line for that particular row.

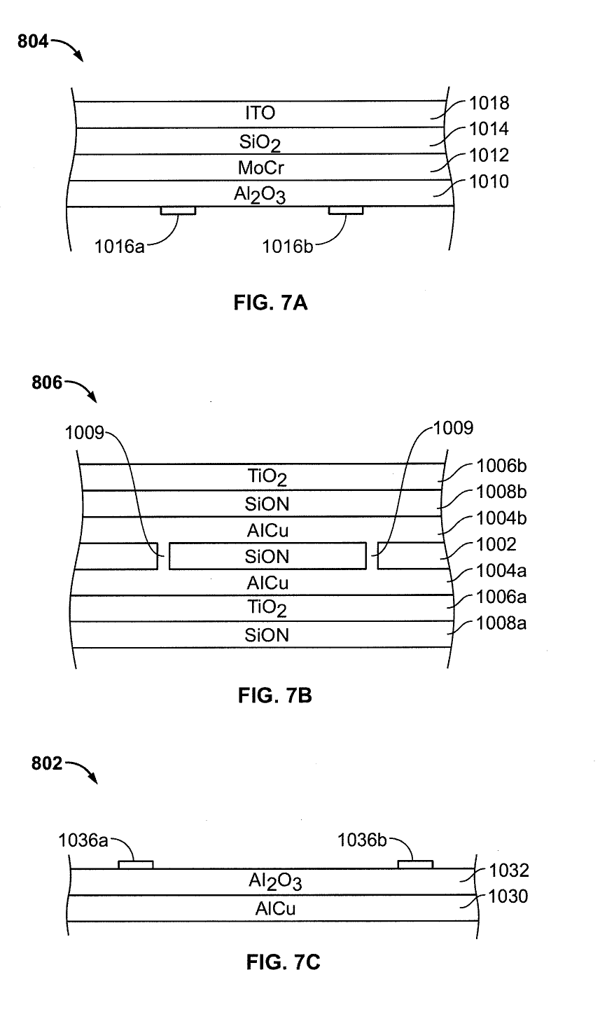

FIGS. 7A-7C show cross-sections of the two fixed layers and the movable layer of the interferometric modulator of FIG. 5 illustrating stacks of materials.

In the implementation illustrated in FIGS. 7A and 7B, the movable third layer 806 and the second layer 804 each include a stack of materials. For example, the movable third layer 806 includes a stack including silicon oxynitride (SiON), aluminum-copper (AlCu), and titanium dioxide (TiO₂). The second layer 804, for example, includes a stack including silicon oxynitride (SiON), aluminum oxide (Al₂O₃), molybdenum-chromium (MoCr), and silicon dioxide (SiO2).

In the illustrated implementation, the movable third layer 806 includes a SiON substrate 1002 having an AlCu layer 1004a deposited thereon. In this implementation, the AlCu layer 1004a is conductive and may be used as an electrode. In some implementations, the AlCu layer 1004 provides reflectivity for light incident thereon. In some implementations, the SiON substrate 1002 is approximately 500 nm thick, and the AlCu layer 1004a is approximately 50 nm thick. A TiO₂ layer 1006a is deposited on the AlCu layer 1004a, and in some implementations the TiO₂ layer 1006a is approximately 26 nm thick. An SiON layer 1008a is deposited on the TiO₂ layer 1006a, and in some implementations the SiON layer 1008a is approximately 52 m thick. The refractive index of the TiO₂ layer 1006a is greater than the refractive index of the SiON layer 1008a. Forming a stack of materials with alternating high and low refractive indices in this way may cause light incident on the stack to be reflected, thereby acting substantially as a mirror.

As can be seen in FIG. 7B, the movable third layer 806 may in some implementations include an additional AlCu layer 1004b, an additional TiO₂ layer 1006b, and an additional SiON layer 1008b formed on the side of the SiON substrate 1002 opposite the AlCu layer 1004a, TiO₂ layer 1006a, and SiON layer 1008a. Forming the layers 1004b, 1006b, and 1008b may weight the movable third layer 806 approximately equally on each side of the SiON substrate 1002, which may increase the positional accuracy and stability of the movable third layer 806 when translating the movable third layer 806. In such implementations, a via 1009 or other electrical connection may be formed between the AlCu layers 1004a and 1004b such that the voltage of the two AlCu layers 1004a and 1004b will remain substantially equal. In this way, when a voltage is applied to one of these two layers, the other of these two layers will receive the same voltage. Additional vias (not shown) may be formed between the AlCu layers 1004a and 1004b.

In the implementation illustrated in FIG. 7A, the second layer 804 includes a SiO₂ substrate 1010 having an MoCr layer 1012 formed thereon. In this implementation, the MoCr layer 1012 may act as a discharge layer to discharge accumulated charge, and may be coupled to a transistor to selectively effect the discharge. The MoCr layer 1012 also may serve as an optical absorber. In some implementations, the MoCr layer 1012 is approximately 5 nm thick. An Al₂O₃ layer 1014 is formed on the MoCr layer 1012, and may provide some reflectance of light incident thereon and may also serve as a bussing layer in some implementations. In some implementations, the Al₂O₃ layer 1014 is approximately 9 nm thick. One or more SiON stops 1016a and 1016b may be formed on the surface of the Al₂O₃ layer 1014. These stops 1016 mechanically prevent the movable third layer 806 from contacting the Al₂O₃ layer 1014 of the second layer 804 when the movable third layer 806 is deflected fully towards the second layer 804. This may reduce stiction and snap-in of the device. Further, an electrode layer 1018 may be formed on the SiO₂ substrate 1010, as shown in FIG. 7. The electrode layer 1018 may include any number of substantially transparent electrically conductive materials, with indium tin oxide being one suitable material.

Layer 802 illustrated in FIG. 7C can be made with simple structure as it has few optical and mechanical requirements it must fulfill. This layer may include a conductive layer of AlCu 1030 and an insulating Al₂O₃ layer 1032. As with layer 804, one or more SiON stops 1036a and 1036b may be formed on the surface of the Al₂O₃ layer 1032.

FIG. 8 shows a schematic representation of the interferometric modulator and voltage sources illustrated in FIG. 5. In this schematic, the modulator is coupled to the voltage sources V₀ and Vₘ. Those of skill in the art will appreciate that the gap between the first layer 802 and the movable third layer 806 forms a capacitor C₁ having a variable capacitance, while the gap between the movable third layer 806 and the second layer 804 forms a capacitor C₂ also having a variable capacitance. Thus, in the schematic representation illustrated in FIG. 8, the voltage source V₀ is connected across the series coupled variable capacitors C₁ and C₂, while the voltage source Vₘ is connected between the two variable capacitors C₁ and C₂.

Accurately driving the movable third layer 806 to different positions using the voltage sources V₀ and Vₘ as described above, however, may be difficult with many configurations of the interferometric modulator 800 because the relationship between voltage applied to the interferometric modulator 800 and the position of the movable third layer 806 may be highly non-linear. Further, applying the same voltage Vₘ to the movable layers of different interferometric modulators may not cause the respective movable layers to move to the same position relative to the top and bottom layers of each modulator due to manufacturing differences, for example, variations in thickness or elasticity of the middle layers 806 over the entire display surface. As the position of the movable layer will determine what color is reflected from the interferometric modulator, as discussed above, it is advantageous to be able to detect the position of the movable layer and to accurately drive the movable layer to desired positions.

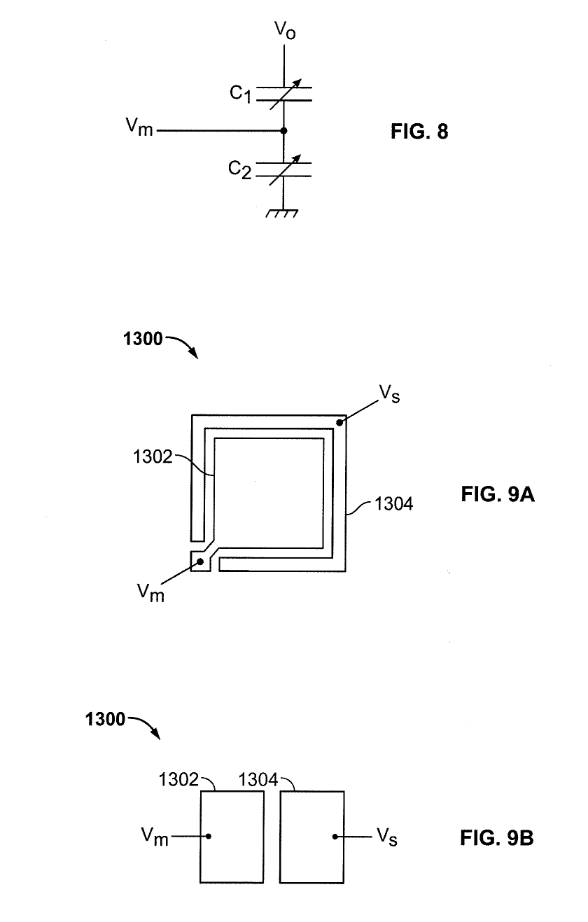

To more accurately drive the movable layer of an analog interferometric modulator, the electrode portion of the movable layer may be separated into two electrically isolated parts. FIG. 9A shows a diagram illustrating a top view of an electrode having two electrically isolated portions. In this implementation, an electrode is divided into a first part 1302 which is electrically isolated from a second part 1304. In the illustrated implementation, the first part 1302 and the second part 1304 are formed as layers in a common plane, and are substantially square or otherwise rectangular in shape. In other implementations, the parts 1302 and 1304 may be roughly circular or oval, or one or both of the parts 1302 and 1304 may be configured as a different shape. For example, the first part 1302 may be configured in an octagonal shape while the second part 1304 is configured as a square shape with a cutout to accept the octagonally-shaped first part 1302. As shown in FIG. 9A, the second part 1304 may be formed around the perimeter of the first part 1302. Those of skill in the art will recognize that it is not necessary that the first part 1302 be located within the second part 1304 when the first and second parts 1302 and 1304 are arranged concentrically. Instead, the second part 1304 may be partially, substantially, or fully within the first part 1302.

In some implementations, the parts 1302 and 1304 are disposed adjacent each other, such as in a side-by-side configuration. FIG. 9B shows a diagram illustrating a top view of another electrode having two electrically isolated portions. FIG. 9B illustrates a top view of an implementation of the electrode divided into a first part 1302 which is adjacent a second part 1304. Each of the first and second parts 1302 and 1304 may be selected as a different size or shape than shown in FIG. 9B, and the size and shape of the first part 1302 need not match the size and shape of the second part 1304. For example, the first part 1302 may be substantially rectangular, while the second part 1304 may be substantially oval. Those of skill in the art will appreciate that the position of the first part 1302 with respect to the second part 1304 may be configured in any number of ways, and that the first and second parts 1302 and 1304 may be rotated or moved into configurations other than those shown in FIGS. 9A and 9B.

The movable third layer 806 may include the electrode configurations discussed with respect to FIGS. 9A and 9B. For example, the AlCu layers 1004a and 1004b of FIG. 7B may be patterned into the first part 1302 and the second part 1304 of the electrode. In one implementation, portions of the first part 1302 are formed as layers in a common plane with at least some portions of the second part 1304. The first part 1302, however, is electrically isolated from the second part 1304. Both the first part 1302 and the second part 1304 may be provided with internal vias to connect the metal layers as shown in FIG. 7.

Referring back to FIGS. 9A and 9B, the first part 1302 of the electrode may be coupled to the voltage source Vₘ, for example when the electrode is implemented in the movable third layer 806 as discussed above with respect to FIG. 7. If the electrode is placed between the first layer 802 and the second layer 804, while voltages are applied by the voltage sources V₀ and Vₘ, as previously described, not only will the first part 1302 move in response to the electrostatic forces, but movement of the first part 1302 will also cause movement of the second part 1304 because they are both part of the same flexible membrane.

As the second part 1304 is moved, a voltage will be induced in the second part 1304 at each different position to which it is moved. This induced voltage can be sensed or detected as a voltage Vₛ. Because the capacitive coupling between the electrode 1302 and electrode 1304 is small, the voltage V, is substantially isolated from the voltage supplied by the voltage source Vₘ, to the electrode 1302. The voltage Vₛ will be dependent on the voltage supplied by the voltage source V₀ and the position of the electrode 1304 relative to the upper layer 804 and the lower layer 802. By comparing the voltage Vₛ to the voltage supplied by the voltage source V₀, the position of the second part 1304, and thus the movable third layer 806, may be determined. In some implementations, depending on the relative sizes and shapes of the two isolated portions, the voltage source Vₘ is coupled to the second part 1304 instead of the first part 1302, and the voltage Vₛ is sensed from the first part 1302. Those of skill in the art will appreciate various devices and apparatuses that may be coupled to the first or second parts 1302 or 1304, depending on the configuration of electrode, and used as a voltage sensor to measure the voltage Vₛ.

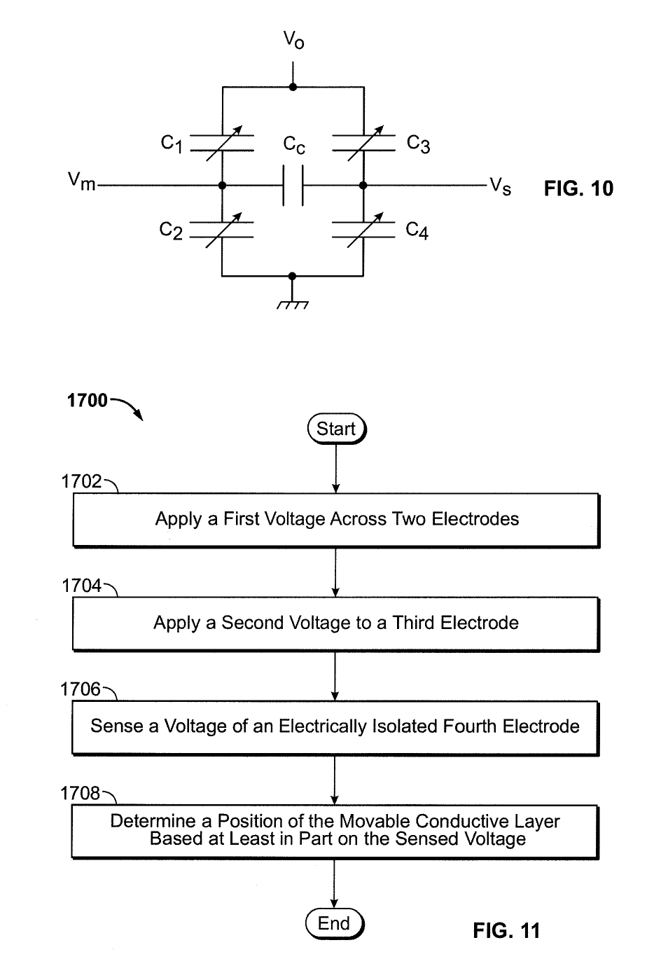

FIG. 10 shows a schematic representation of the electrode of FIG. 9A or 9B implemented in the interferometric modulator of FIG. 5. In this schematic representation, the movable third layer 806 is implemented with the split electrode 1302, 1304 and the modulator is coupled to the voltage sources V₀ and Vₘ. The gap between the first layer 802 and the first part 1302 of the electrode forms the variable capacitor C₁. Similarly, the gap between the first part 1302 and the second layer 804 forms the variable capacitor C₂. The gap between the first layer 802 and the second part 1304 of the electrode forms a capacitor C₃ with a variable capacitance, while the gap between the second part 1304 and the second layer 804 forms a capacitor C₄ with a variable capacitance. The capacitances of C₃ and C₄ are proportional to C₁ and C₂, respectively, by a factor γ, where γ is equal to the area of the second part 1304 divided by the area of the first part 1302. The two electrically isolated parts 1302 and 1304 form a fifth capacitor C_{c}. The capacitance of C_{c} may be referred to as the coupling capacitance between the two electrically isolated parts 1302 and 1304.

As described above, the position of the movable third portion 806 may be determined by measuring the voltage Vₛ. If the capacitance of C_{c} is assumed to be zero, the circuit illustrated in FIG. 10 operates as a voltage divider and the voltage Vₛ will be generated according to the following equation:

Vₛ=V₀*C₂/(C₁+C₂) (1)

where V₀ in equation (1) is used to represent the voltage supplied by the voltage source V₀ and C₁ and C₂ in equation (1) are used to represent the capacitances of the capacitors C₁ and C₂, respectively. If the movable third layer 806 is centered between the first layer 802 and the second layer 804 when in the equilibrium position, then Vₛ will generally be proportional to the displacement of the movable third layer 806 from the equilibrium position. In this configuration, if the distance between the equilibrium midpoint position of layer 806 and the upper or lower layer 802 or 804 is represented by d, and the displacement of the mirror from the equilibrium midpoint position is represented by x (which can be positive or negative depending on the direction of displacement), the value of x can be determined using the following equation:

x=d((2Vₛ/V₀)−1) (2)

The position of the movable third layer 806 may thus be determined from the sensed voltage Vₛ.

The position of the movable third layer 806 may be determined with more specificity by determining the capacitance of C_{c} and including this capacitance in the position calculation. If the movable third layer 806 is centered between the first layer 802 and the second layer 804 when in the equilibrium position, Vₛ can be determined using the following equation:

$${V}_{s} = \frac{{C}_{2} {V}_{0}}{( {C}_{1} + {C}_{2} ) ( 1 + \frac{{C}_{c}}{γ ( {C}_{1} + {C}_{2} )} )} + ( \frac{{C}_{c} {V}_{m}}{γ ( {C}_{1} + {C}_{2} )} ) \qquad ( 3 )$$

where Vₘ in equation (1) is used to represent the voltage supplied by the voltage source Vₘ. By noting that the capacitances C₁ and C₂ will depend on the area of the first part 1302 and the displacement of the first part 1302 from the equilibrium position, and observing that C_{c}<<C₂, C₁ and thus keeping the error in sensing to first order in C_{c}, Vₛ will be generated according to the following equation:

$${V}_{s} \approx \frac{( d + x ) {V}_{0}}{2 d} ( 1 - \frac{{C}_{c}}{γ ( {C}_{1} + {C}_{2} )} ) + \frac{{C}_{c} {V}_{m}}{γ ( {C}_{1} + {C}_{2} )} . \qquad ( 4 )$$

This sensed voltage Vₛ can therefore be used to probe the actual response of the movable third layer 806 to supplied voltages Vₘ. The electrode may be configured to minimize the coupling capacitance or to maintain the coupling capacitance below a predetermined value so that the dependence on Vₘ is negligible. For example, when the electrically isolated parts 1302 and 1304 are disposed in a side-by-side configuration such as shown in FIGS. 9A and 9B, the coupling capacitance may be maintained low.

Although the above implementations have been described with respect to an analog interferometric modulator, those of skill in the art will appreciate that the teachings herein are not limited to such implementations. For example, sensing a voltage as described above may be used to determine the position of any movable conductor or electrode positioned between two other electrodes or conductors, for example two other substantially stationary or fixed electrodes or conductors. In some implementations, the two other electrodes are configured to move or translate while a middle electrode or conductor between the two is substantially fixed or stationary. In all of these implementations, the middle electrode may be separated into two or more electrically isolated parts, and at least one of the parts may be coupled to a voltage sensor.

FIG. 11 shows a flow diagram of a process for determining a position of a movable conductive layer disposed between two fixed conductive layers.

At block 1702, a first voltage is applied across two electrodes. For example, the voltage source V₀ may be used to apply a voltage across electrodes of the first layer 802 and the second layer 804 of the interferometric modulator 800. At block 1704, a second voltage is applied to a third electrode. For example, the voltage source Vₘ may be used to apply a voltage to an electrode or portion thereof, such as the first part 1302 of the electrode of the movable third layer 806. At block 1706, a voltage of an electrically isolated fourth electrode is sensed. For example, the voltage Vₛ may be sensed from the second part 1304 of the movable third layer 806. At block 1708, a position of the movable third layer 806 is determined based at least in part on the sensed voltage.

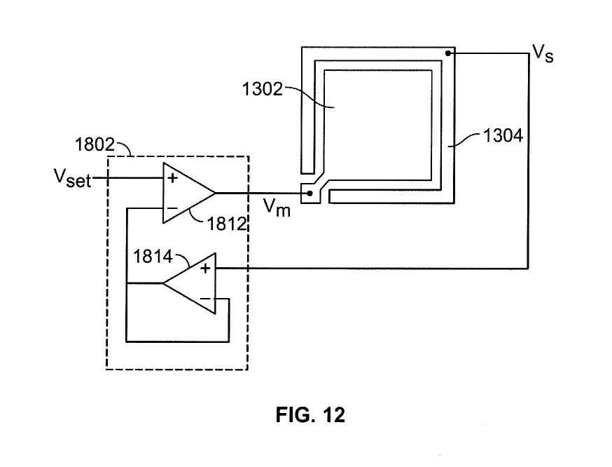

FIG. 12 shows an illustration of a voltage sensor configured to provide feedback to the electrode of FIG. 9A. FIG. 12 illustrates an implementation of a voltage sensor 1802 configured as a position determination unit that also provides feedback to the electrode 1302. In this implementation, the sensed voltage Vₛ is used in a feedback circuit to correct the position of the electrode, and therefore the position of the movable third layer 806 when implemented using the electrode.

As can be seen in FIG. 12, a voltage source Vₛₑₜ is coupled to an input of an operational amplifier (“op-amp”) 1812, while the output of the op-amp 1812 is coupled to one of the electrically isolated parts of the electrode. The illustrated implementation shows the voltage source Vₛₑₜ being coupled to a positive input of the op-amp 1812, and shows the output of the op-amp 1812 being coupled to the first part 1302. In the illustrated implementation, a negative input of the op-amp 1812 is coupled to the output of a voltage follower 1814. In this implementation, the sensed voltage Vₛ from the second part 1304 is coupled to an input of the voltage follower 1814, while the output of the voltage follower 1814 is coupled to the negative input of the op-amp 1812. The output of the voltage follower is a measure of the position of the middle layer 806 that the electrodes 1302 and 1304 are coupled to. This measure of position is used as an input to the op-amp 1812.

In the configuration illustrated in FIG. 12, the output V₀, of op-amp 1812 will go to whatever value is necessary to make Vₛ nearly equal to Vₛₑₜ. Thus, with the feedback loop of FIG. 12, the middle layer 806 can be placed at a desired position x between the upper and lower layers 802 and 804 by selecting an applied Vₛₑₜ that is equal to the value of Vₛ which is generated when the layer is at the desired value of x per Equation 2 above. The relationship between the applied Vₛₑₜ and the value of x may be approximately linear, with an applied Vₛₑₜ between 0 and V₀ producing an x ranging from −d to +d.

Driving an interferometric modulator with feedback as described above may reduce the effects of the snap-in characteristics of interferometric modulators. The term “snap-in” refers to the characteristic of these devices that as the middle electrode moves toward one of the fixed electrodes 802 or 804 under the influence of a voltage applied to electrode 1302, a point is reached where small changes to the applied voltage cause the middle electrode 806 to suddenly move all the way upward or downward against one of the fixed electrodes. This phenomena reduces the useful range of controlled motion of the middle layer in many such devices. A feedback loop such as shown in FIG. 12 allows for finer control of position, and increases the useful controlled range of these devices. Further, complications arising from variations in individual modulators, for example due to manufacturing differences, may be reduced. Thus, although voltages required to drive different movable layers in an array of interferometric modulators may differ slightly because of variations and tolerances in the manufacturing of those modulators, the feedback of FIG. 12 may be used to accurately position all the movable layers using consistent driving voltages Vₛₑₜ. Further, oscillations or instability of the movable layer may be corrected in real-time by the feedback.

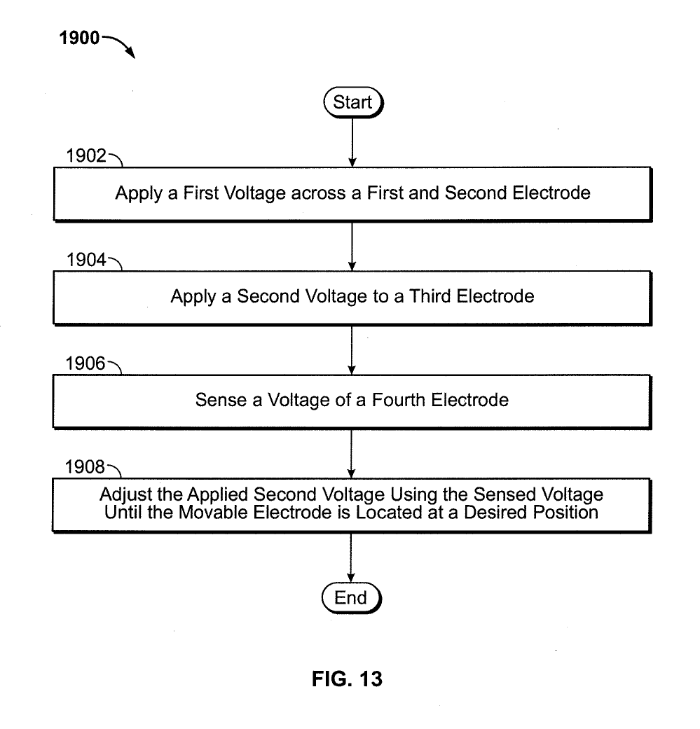

FIG. 13 shows a flowchart of a process for driving a device for modulating light.

At block 1902, a first voltage is applied across first and second electrodes. For example, a voltage from the voltage source V₀ may be applied across electrodes of the first layer 802 and the second layer 804. At block 1904, a second voltage is applied to a third electrode. In the implementation of FIG. 12, the third electrode is configured as a portion of a movable electrode, and is disposed between and spaced apart from the first and second electrode. For example, a voltage from the voltage source Vₘ may be applied to a portion of an electrode, such as the first part 1302 of the electrode of the movable third layer 806. At block 1906, a voltage of a fourth electrode is sensed. For example, the voltage Vₛ may be sensed from the second part 1304. At block 1908, the sensed voltage is used to adjust the applied second voltage until the movable electrode is located at a desired position. For example, the sensed voltage Vₛ may be used by the op-amp 1812 to adjust voltage applied to the third electrode until Vₛ and the voltage received from the voltage source Vₘ are approximately equal and the movable electrode 806 is located at a desired offset from the equilibrium position.

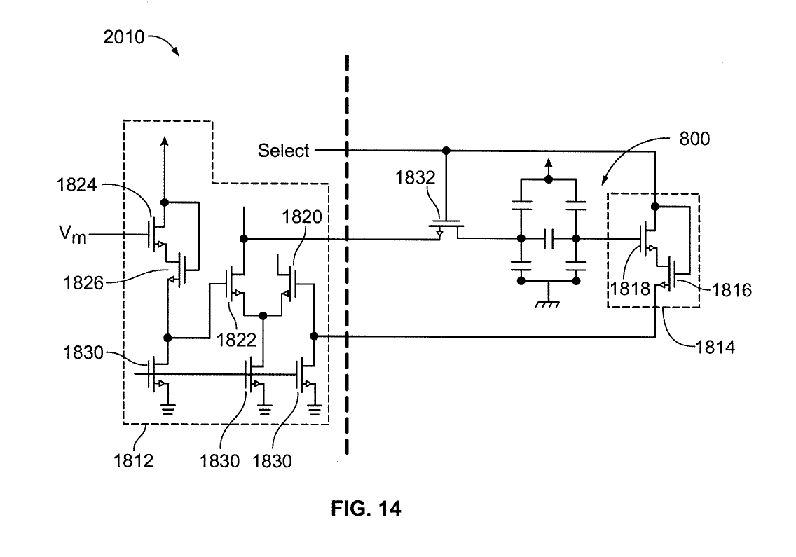

FIG. 14 shows a circuit diagram illustrating an implementation of the sensor and feedback of FIG. 12. As can be seen in FIG. 14, the op-amp 1812 and the voltage follower 1814 may each be implemented using a plurality of transistors. In this implementation, the voltage follower 1814 is implemented as a pair of transistors 1816 and 1818. The gate of transistor 1818 is coupled to the sense electrode 1304 to provide the Vₛ input to the voltage follower 1814. The drain of transistor 1818 is connected to a select line. The source of transistor 1818 is coupled to the drain of transistor 1816, and the gate of transistor 1816 is connected to the drain of transistor 1818. The source of transistor 1816 forms the output of voltage follower 1814, and is coupled to a first transistor 1820 of a differential pair including transistor 1820 and transistor 1822 of the op-amp 1812. The Vₘ input is provided to the gate of the other transistor 1822 of the differential pair of the op-amp through a voltage follower made up of transistors 1824 and 1826, connected in the same manner as transistors 1816 and 1818. Bias current for the differential pair and the voltage followers is provided by transistors 1830. The output of the differential pair is connected to the source of select transistor 1832, which has its gate coupled to the select line. The drain of the select transistor 1832 is coupled to the electrode 1302. When the select transistor 1832 is turned on with the select signal applied to its gate, the output of the differential pair will reach a voltage where the sense voltage Vₛ equals the input voltage Vₘ. Thus, the sensor 1802 may be implemented efficiently and cost-effectively using appropriate elements.

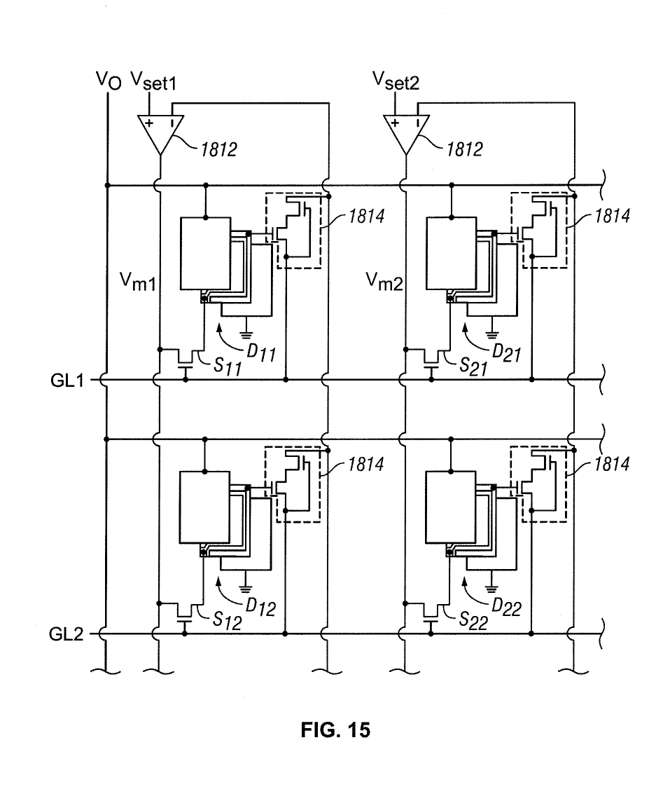

FIG. 15 shows a diagram illustrating an array of interferometric modulators incorporating voltage sensing and feedback to position a middle layer of each modulator. As described above with respect to FIGS. 2 and 6, a data driver circuit supplies a row of data voltages Vₛₑₜ₁ through Vₛₑₜₙ. A gate driver circuit provides row select voltages that apply a set of data voltages to a selected row of display elements. Each column is provided with a feedback amplifier 1812, and each display element is provided with a voltage follower 1814. The feedback amplifiers 1812 and voltage followers 1814 may be incorporated into the backplate 120 as described above with regard to the drive transistors S₁₁, S₁₂, etc.

To set the positions of the display elements in row 1, for example, the Vₛₑₜ₁ through Vₛₑₜₙ outputs are set according to the desired position of each middle layer 806 along the row. For example, if the middle layer for S₁₁ should be in the central equilibrium position, then Vₛₑₜ₁ is set to 0.5V₀. If the middle layer for S₁₂ should be halfway between the central equilibrium position and the grounded layer 804, then Vₛₑₜ₂ is set to 0.75V₀, etc. When each Vₛₑₜ for a row is appropriately set, gate line GL1 is asserted, coupling the output of each feedback amplifier 1812 to the electrode 1302 of each display element along the row. Gate line GL1 assertion also causes the sensed voltage Vₛ for each display element along the first row to be fed back to each respective feedback amplifier. As described above with respect to FIGS. 12 and 13, this sets each display element along the row to the desired position x depending on the applied data voltage Vₛₑₜ. This process is then repeated for each row to complete the process of writing a full frame of image data.

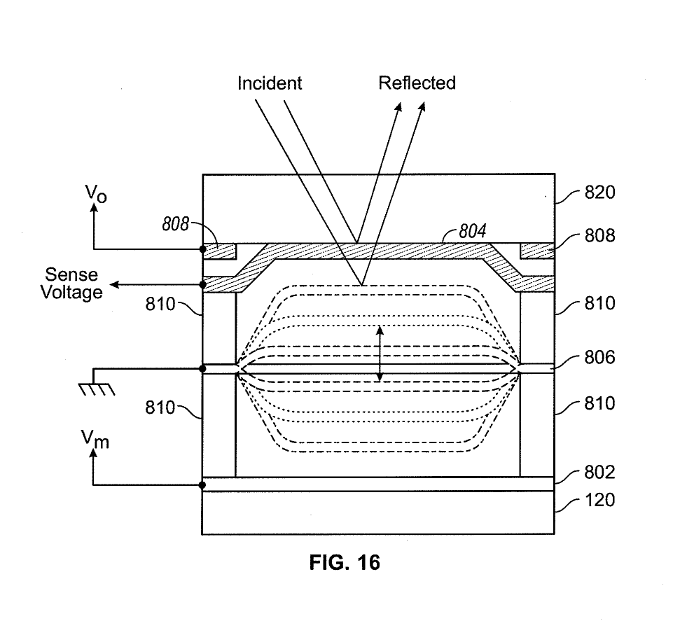

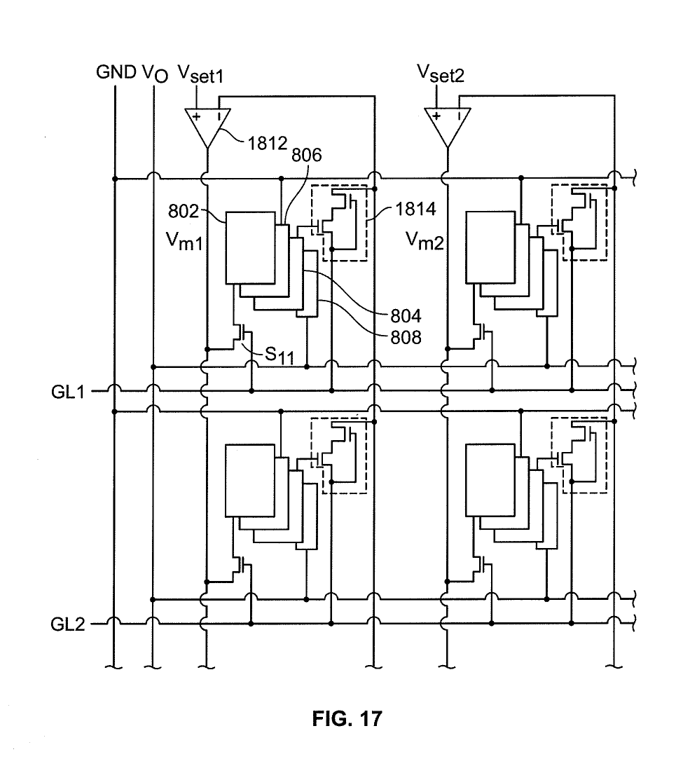

FIG. 16 shows a cross-section of an interferometric modulator having fixed layers and a movable layer with a fixed sense electrode. In this implementation, the fixed voltage V₀ is applied across fixed electrode 808 and the movable layer 806, with the movable layer 806 grounded in this implementation. The electrode 808 may be formed in a peripheral region of another fixed electrode 804 or can be a uniform thin film capacitor formed by an additional dielectric layer between 808 and 804, making 804 uniform across the entire pixel area. In the implementation illustrated in FIG. 16, the electrode 808 wraps partially or fully around the electrode 804, although it is suitable for the electrode 808 to be on only one side of the electrode 804. The variable voltage Vₘ is applied to a fixed electrode 802 on the other side of the movable layer 806. The fixed electrode 804 is used as the sense electrode. When the variable voltage Vₘ is zero, the voltage V₀ on the electrode 808 pulls the movable layer 806 toward the sense electrode 804 and the voltage of the sense electrode 804 is forced toward zero. As the variable voltage Vₘ is increased, the movable layer 806 is pulled toward the electrode 802, and the voltage on the sense electrode 804 increases. In some implementations, the voltage on the sense electrode 804 is a nearly linear function of the position of the movable layer 806. Thus, similar to the implementation described above, the voltage on the sense electrode 804 can be used to determine the position of the movable layer 806. In this implementation, the grounded movable layer 806 shields the sense electrode 804 from the changing voltage levels on the electrode 802, making the sense voltage mainly dependent on the position of the movable layer 806, regardless of the voltage Vₘ used to produce that position. Feedback can be incorporated into this implementation in a manner similar to that described above, as illustrated in FIG. 17.

FIG. 17 shows a diagram illustrating another implementation of an array of interferometric modulators constructed as shown in FIG. 16 incorporating voltage sensing and feedback to position a movable layer of each modulator in a display system. Each interferometric modulator can be configured as a display element in the display system. As shown in FIG. 17, the voltage follower 1814 of FIG. 15 is connected to the fixed electrode 804. The output of the voltage follower 1814 provides an input to operational amplifier 1812. In this implementation, the known relationship between sense voltage output and the position of the movable layer 806 is used to determine the values for Vₛₑₜ₁ through Vₛₑₜₙ along a row to position the movable layers 806 along a row to their desired positions. This relationship may be stored as a formula or as a look up table that is accessed by the display system. If the relationship is different for different display elements, specific values for each element can be stored and used when setting the state of each display element. When the gate line (GL1 for example) is asserted, the switch S₁₁ will be closed, and thus passing the output voltage Vₘ₁ of the operation amplifier 1812 onto the fixed electrode 802. As explained above with reference to FIG. 16, increasing the voltage on the fixed electrode 802 from zero to Vₘ₁ can cause the movable layer 806 to pull towards the electrode 802, and the voltage on the sense electrode 804 increases. The voltage on the sense electrode 804 is input into the voltage follower 1814, which provides an input to the operational amplifier 1812 as a feedback signal. As such, the outputs of the operation amplifiers (including operational amplifier 1812) will move to the voltages Vₘ that make the sense voltages equal to the input Vₛₑₜ values, thus placing the movable layer 806 of each display element along the row at the desired position.

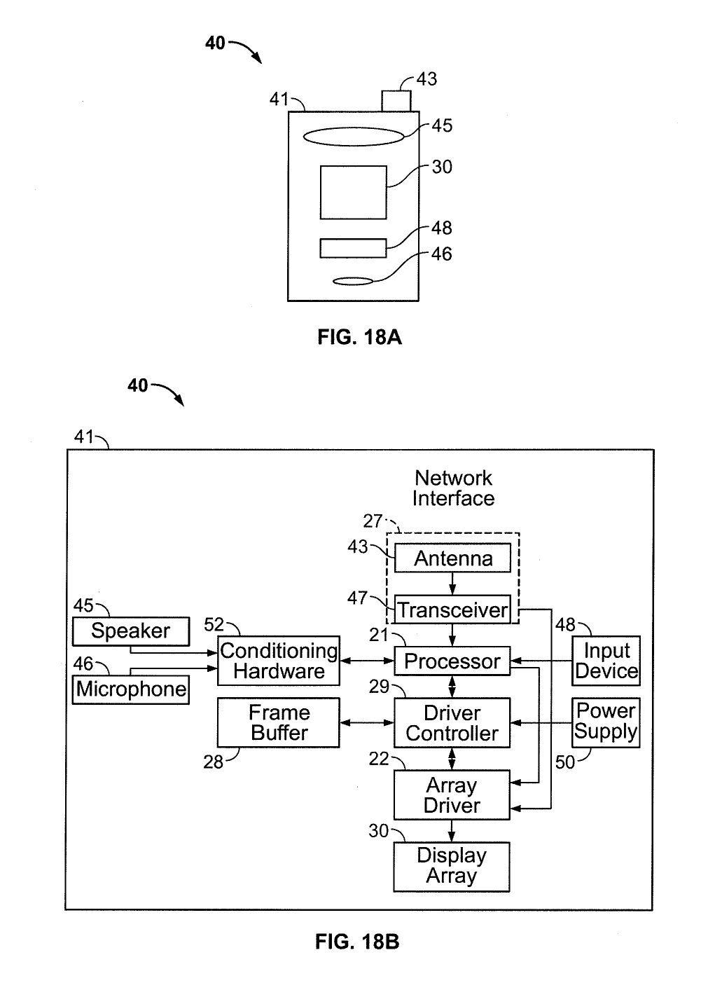

FIGS. 18A and 18B show examples of system block diagrams illustrating a display device 40 that includes a plurality of interferometric modulators. The display device 40 can be, for example, a smart phone, a cellular or mobile telephone. However, the same components of the display device 40 or slight variations thereof are also illustrative of various types of display devices such as televisions, tablets, e-readers, hand-held devices and portable media players.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an interferometric modulator display, as described herein.

The components of the display device 40 are schematically illustrated in FIG. 18B. The display device 40 includes a housing 41 and can include additional components at least partially enclosed therein. For example, the display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g., filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the BLUETOOTH standard. In the case of a cellular telephone, the antenna 43 is designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G or 4G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that is readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of pixels.

In some implementations, the driver controller 29, the array driver 22, and the display array 30 are appropriate for any of the types of displays described herein. For example, the driver controller 29 can be a conventional display controller or a bi-stable display controller (such as an IMOD controller). Additionally, the array driver 22 can be a conventional driver or a bi-stable display driver (such as an IMOD display driver). Moreover, the display array 30 can be a conventional display array or a bi-stable display array (such as a display including an array of IMODs). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with display array 30, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

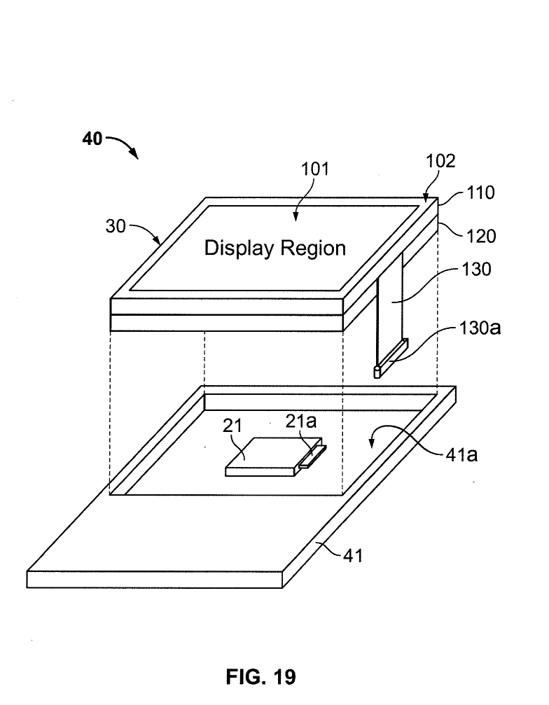

FIG. 19 is an example of a schematic exploded perspective view of the electronic device having an optical MEMS display. The illustrated electronic device 40 includes a housing 41 that has a recess 41a for a display 30. The electronic device 40 also includes a processor 21 on the bottom of the recess 41a of the housing 41. The processor 21 can include a connector 21a for data communication with the display 30. The electronic device 40 also can include other components, at least a portion of which is inside the housing 41. The other components can include, but are not limited to, a networking interface, a driver controller, an input device, a power supply, conditioning hardware, a frame buffer, a speaker, and a microphone, as described earlier in connection with FIG. 16B.

The display 30 can include a display array assembly 110, a backplate 120, and a flexible electrical cable 130. The display array assembly 110 and the backplate 120 can be attached to each other, using, for example, a sealant.

The display array assembly 110 can include a display region 101 and a peripheral region 102. The peripheral region 102 surrounds the display region 101 when viewed from above the display array assembly 110. The display array assembly 110 also includes an array of display elements positioned and oriented to display images through the display region 101. The display elements can be arranged in a matrix form. In one implementation, each of the display elements can be an interferometric modulator. In some implementations, the term “display element” also may be referred to as a “pixel.”

The backplate 120 may cover substantially the entire back surface of the display array assembly 110. The backplate 120 can be formed from, for example, glass, a polymeric material, a metallic material, a ceramic material, a semiconductor material, or a combination of two or more of the foregoing materials, in addition to other similar materials. The backplate 120 can include one or more layers of the same or different materials. The backplate 120 also can include various components at least partially embedded therein or mounted thereon. Examples of such components include, but are not limited to, a driver controller, array drivers (for example, a data driver and a scan driver), routing lines (for example, data lines and gate lines), switching circuits, processors (for example, an image data processing processor) and interconnects.

The flexible electrical cable 130 serves to provide data communication channels between the display 30 and other components (for example, the processor 21) of the electronic device 40. The flexible electrical cable 130 can extend from one or more components of the display array assembly 110, or from the backplate 120. The flexible electrical cable 130 includes a plurality of conductive wires extending parallel to one another, and a connector 130a that can be connected to the connector 21a of the processor 21 or any other component of the electronic device 40.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the disclosure is not intended to be limited to the implementations shown herein, but is to be accorded the widest scope consistent with the claims, the principles and the novel features disclosed herein. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of an IMOD as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, a person having ordinary skill in the art will readily recognize that such operations need not be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A device for modulating light, comprising:
at least first, second, third, and fourth electrodes;
a fixed voltage applied across the first and second electrodes;
a variable voltage applied to the third electrode; and
a voltage sensor coupled to the fourth electrode.

2. The device of claim 1, wherein at least one of the four electrodes is movable.

3. The device of claim 2, wherein the third and fourth electrodes are movable.

4. The device of claim 1, wherein the voltage sensor provides feedback for adjusting the variable voltage.

5. The device of claim 4, further including an operational amplifier, wherein an output of the operational amplifier is coupled to the third electrode.

6. The device of claim 5, further including a voltage follower, wherein an input of the voltage follower is coupled to the fourth electrode, and wherein an output of the voltage follower is coupled to the operational amplifier.

7. The device of claim 1, wherein the third electrode and the fourth electrode are formed as layers in a common plane.

8. The device of claim 3, wherein the third electrode and the fourth electrode are formed as layers in a common plane.

9. The device of claim 8, wherein the fourth electrode is formed around the perimeter of the third electrode.

10. The device of claim 2, wherein the movable electrode includes a mirror layer.

11. The device of claim 2, further including a drive circuit configured to adjust a position of the movable electrode by varying the voltage supplied by the variable voltage source.

12. The device of claim 2, wherein the second electrode is movable.

13. The device of claim 12, wherein the second electrode is grounded.

14. The device of claim 13, wherein the fourth electrode is disposed between the second electrode and the first electrode.

15. The device of claim 14, wherein the first electrode is formed around a peripheral portion of the fourth electrode.

16. The device of claim 1, further comprising:
a display;
a processor that is configured to communicate with the display, the processor being configured to process image data; and
a memory device that is configured to communicate with the processor.

17. The device as recited in claim 16, further comprising:
a driver circuit configured to send at least one signal to the display.

18. The device as recited in claim 17, further comprising:
a controller configured to send at least a portion of the image data to the driver circuit.

19. The device as recited in claim 16, further comprising:
an image source module configured to send the image data to the processor.

20. The device as recited in claim 19, wherein the image source module includes at least one of a receiver, transceiver, and transmitter.

21. The device as recited in claim 16, further comprising:
an input device configured to receive input data and to communicate the input data to the processor.

22. The device of claim 1, including a position determination unit coupled to the fourth electrode and configured to determine a position of a movable conductive layer based at least in part on a voltage sensed from the fourth electrode.

23. A method of driving a device for modulating light, comprising:
applying a first voltage across a first electrode and a second electrode;
applying a second voltage to a third electrode; and
sensing a voltage of a fourth electrode.

24. The method of claim 23, including moving the third electrode and fourth electrode in response to applying the second voltage.

25. The method of claim 23, including moving one of the first or the second electrode in response to applying the second voltage.

26. The method of claim 23, wherein the sensed voltage is used to adjust the applied second voltage until a position of a movable electrode is substantially equal to a desired position.

27. The method of claim 23, wherein the sensed voltage is substantially proportional to an offset of the movable electrode as adjusted by a factor dependent on a capacitance between the third and fourth electrodes.

28. A device for modulating light, comprising:
means for applying a first voltage across a first electrode and a second electrode;
means for applying a second voltage to a third electrode; and
means for sensing a voltage of a fourth electrode.

29. The device of claim 28, additionally including means for determining a position of the movable conductive layer based at least in part on the sensed voltage.

30. The device of claim 29, wherein the means for applying includes an operational amplifier.

31. The device of claim 30, wherein the means for sensing comprises a voltage follower.

32. The device of claim 31, wherein an output of the voltage follower is coupled to an input of the operational amplifier.
